(19) United States
(12) Patent Application Publication
(10) Pub. No.: US 2007/0147201 A1
(43) Pub. Date: Jun. 28, 2007

(54) INFORMATION REPRODUCING APPARATUS AND METHOD

(76) Inventor: Katsuyuki NOMURA, Hino-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/567,332

(22) Filed: Dec. 6, 2006

(30) Foreign Application Priority Data
Dec. 22, 2005 (JP) 2005-369571

(51) Int. Cl. G11B 20/10

(52) U.S. Cl. 369/47.14; 369/53.37

(57) ABSTRACT

According to one embodiment of this invention, a first management information holding section holds first reproduction management information recorded on an optical disc and a second management information holding section holds second reproduction management information fetched from the exterior. A flag determining section determines whether a write end flag of the second reproduction management information is normal or not, a newest information determining section determines a newer one of the first and second reproduction management information items and a reproduction management information selecting section issues an instruction to reproduce the contents by use of the newer one of the reproduction management information items.

### CROSS-REFERENCE TO RELATED APPLICATIONS

This application is based upon and claims the benefit of priority from Japanese Patent Application No. 2005-369571, filed Dec. 22, 2005, the entire contents of which are incorporated herein by reference.

### BACKGROUND

1. Field

One embodiment of the invention relates to an information reproducing apparatus and, for example, it attains an effective function when this invention is applied to an information reproducing apparatus of a type in which management information is updated.

2. Description of the Related Art

In recent years, optical discs are developed and popularly used as media such as digital versatile discs (DVDs) which store video/audio works of movies and music formed in a digital form, for example. Such DVDs are made public as DVD books in a format formed by the DVD forum (refer to world wide web. dvdforum.org) and defined according to International Standard or JIS.

Discs having further larger capacity in comparison with the above DVDs (which are hereinafter referred to as existing DVDs) are developed. The discs are developed since it is desired to store a high-definition (HD) video image in one disc (which is temporarily referred to as a next-generation DVD). The next-generation DVD is standardized as an HD DVD (High Density DVD).

On the above DVD, contents such as movies and music and management information required for reproducing the contents are recorded. The reproducing apparatus first reads out management information, acquires the physical characteristic of the disc and the recorded contents, determines the reproduction procedure and reproduces the contents such as actual movies and music.

In the HD DVD standard, it is permitted to replace management information (which is hereinafter referred to as original information, for example) originally recorded on the disc as management information by management information (which is hereinafter referred to as updated information so as to be separated from the original information) updated via Internet.

The updated information is supplied by a provider and held in the reproducing apparatus. Further, as the updated information, not only the management information but also contents themselves used to complement part of movies and music are contained.

As the technique for dealing with a case wherein a plurality of management information items are present, for example, the technique disclosed in Jpn. Pat. Appln. KOKAI Publication No. 2004-240832 (Document 1) is provided. In the technique, an apparatus which deals with a plurality of recording media is disclosed. In the apparatus, when a second recording medium is loaded while a first recording medium is being reproduced, reproduction management information is re-structured while the reproducing operation is being performed and then the reproducing operation is performed according to the re-structured reproduction management information after the reproducing operation of a track which is now reproduced is terminated.

As described above, the technique for re-structuring management information and replacing the management information is disclosed in Document 1. In the reproducing apparatus for HD DVDs, updated information is fetched via Internet and used in some cases. In this case, the measure for ensuring the safety of the updated information is unsatisfactory (insufficient). If faults occur in the updated information, the reproducing apparatus falls into a deadlock state and there occurs a problem that the user will have distrust.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the whole configuration of an information reproducing apparatus to which this invention is applied.

FIG. 2 is a configuration explanatory diagram showing one example of part of the main portion of one embodiment of this invention.

FIG. 3 is a flowchart for illustrating the operation in one embodiment of this invention.

FIG. 4 is a flowchart for illustrating the operation in another embodiment of this invention.

FIG. 5 is a flowchart for illustrating the operation in still another embodiment of this invention.

FIG. 6 is an explanatory view showing an example of a screen image displayed on a display by an information reproducing apparatus to which this invention is applied.

FIG. 7 is a block diagram showing the whole configuration in another embodiment of an information recording/reproducing apparatus to which this invention is applied.

### DETAILED DESCRIPTION

Various embodiments according to the invention will be described hereinafter with reference to the accompanying drawings.

In one embodiment of this invention, since first reproduction management information can be used even when faults occur in second reproduction management information, the reproduction state of the apparatus can be ensured. Further, if both of the reproduction management information items are normal, the newest of the reproduction management information items can be used.

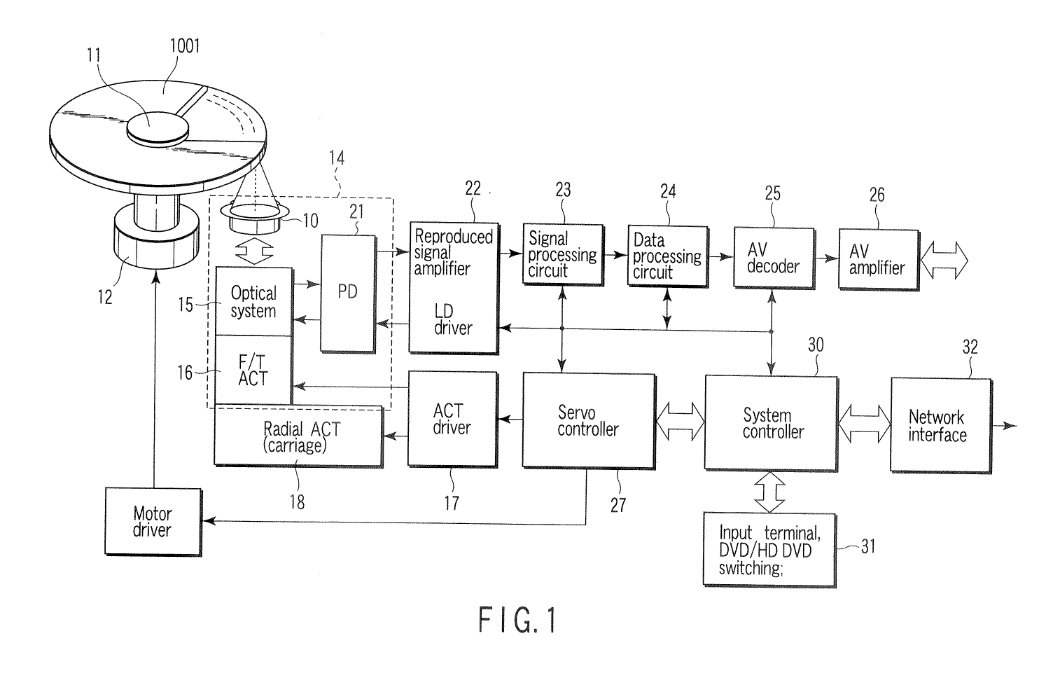

The embodiment of this invention is explained below with reference to the accompanying drawings. FIG. 1 shows the configuration of the main portion of an information reproducing apparatus (DVD device) to which this invention is applied. The apparatus is simply explained below. A spindle motor 12 rotates and drives a turntable. A damper 11 holds an optical disc 1001 on the turntable. The spindle motor 12 is controlled by a motor driver 13.

An optical head 14 includes an objective lens 10 and optical system 15. The optical system 15 is driven by a focusing and tracking actuator 16. If the focusing and tracking actuator 16 is controlled by an actuator driver 17, laser light is focused on a track of the optical disc and follows the track. A radial actuator 18 moves the optical head 14 in a radial direction of the disc and is controlled by the actuator driver 17.

Reflected light from the disc is derived from the optical system 15 and converted into an electrical signal by a photodetector of a conversion unit 21. The electrical signal is input to a gain adjusting unit 22. The gain adjusting unit 22 is a block including a reproduced signal amplifier and laser diode (LD) driver. The reproduced signal from the conversion unit 21 is subjected to gain adjustment by the reproduced signal amplifier and input to a signal processing circuit 23. In the signal processing circuit 23, a demodulation process, buffering process and error correction process are performed and an output thereof is input to a data processing circuit 24.

In the processing circuit, a packet separation process and control signal separation process are performed and video and audio information items are input to an AV decoder 25. The video signal, audio signal, sub video signal and the like demodulated by the AV decoder 25 are output as a baseband signal via an AV amplifier 26.

For example, a servo controller 27 supplies a control signal to the actuator driver 17 by use of a focus error signal and tracking error signal obtained by processing a reproduced signal from a four-division photodiode.

A system controller 30 controls the reproduction, stop and temporary stop operations of the apparatus in response to a signal from an input terminal (for example, a remote controller or operation key-input section) 31. Further, it controls a laser diode driver in the gain adjustment unit 22. The laser diode driver drives a red laser diode or blue laser diode mounted on the optical head 14. The system controller 30 generally controls the blocks of the respective sections of the reproducing apparatus.

The optical head 14 functions as a reading section which reads out information from an information recording medium. The gain adjustment unit 22, signal processing circuit 23, data processing circuit 24, AV decoder 25 and the like function as a signal processing section which processes a signal output from the reading section. The system controller 30 functions as a control section which controls the reproducing operation. Further, the network interface 32 is connected to an external network under the control of the control section.

When the optical disc 1001 is loaded, the spindle motor 12 is rotated to a preset rotation speed. Then, the tracking-ON operation is performed by use of a focus control loop and tracking control loop. In this state, ID of “Data frame” is read out, “Area type”, “Reflectivity”, “layer number” and the like of the disc are checked and the optical head 14 is moved to “Lead in area”. Next, the optical head 14 is moved to “Control data zone” to read out “Physical format information” and the system controller 30 confirms the DVD disc. Further, various types of management information items are read out and the information reproducing apparatus is set into the DVD video and audio information reproducing state based on the management information.

Further, the information reproducing apparatus can be connected to Internet via the network interface 32. In a case wherein an optical disc which is previously devised and designed by the provider is used, the system controller 30 can be connected to a server specified by the provider by use of an address recorded on the optical disc. Then, the newest reproduction management information used to reproduce the contents of the optical disc or part of the contents such as video and audio information can be fetched into a memory (not shown) of the information reproducing apparatus. As the memory, a semiconductor memory or hard disc can be used.

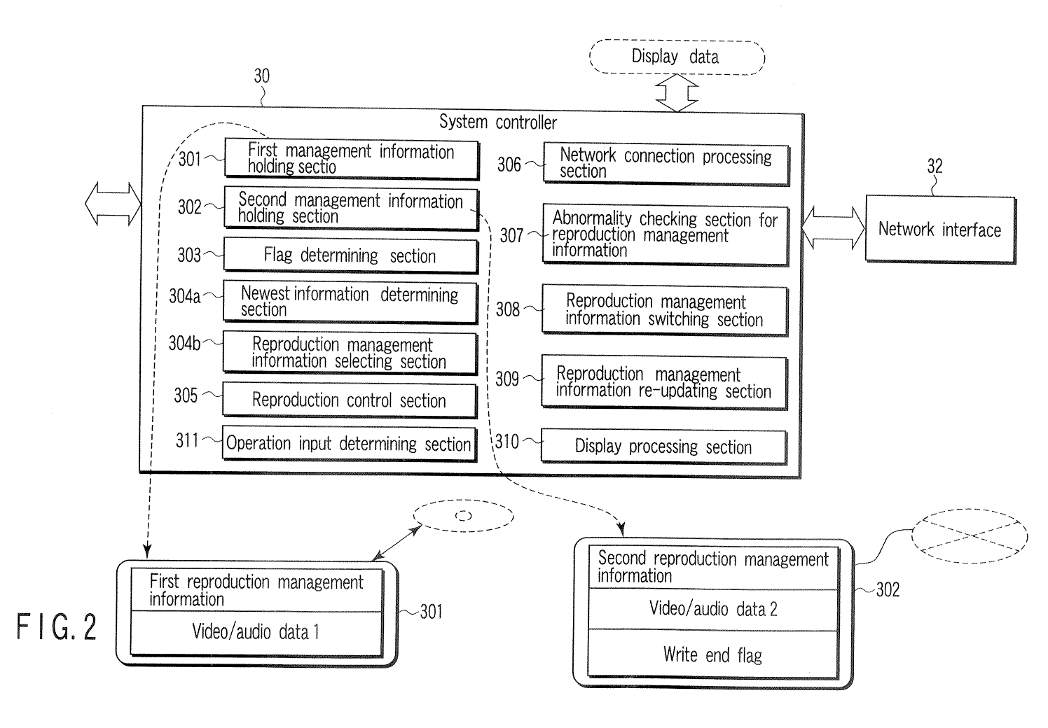

FIG. 2 shows the characteristic portion of this invention. The information reproducing apparatus of this invention includes a first management information holding section 301 which holds first reproduction management information used to reproduce the contents of the optical disc 1001 (information recording medium) and a second management information holding section 302 which holds second reproduction management information used to reproduce the contents from the optical disc 1001 and/or exterior. A write end flag is attached to the second reproduction management information. The write end flag is attached to identify the end of data when the second reproduction management information is fetched via Internet.

Whether or not the write end flag is normal is determined by a flag determining section 303. When the write end flag is normal, a newest information determining section 304a determines version information items of the first and second reproduction management information items and determines a newer one of the reproduction management information items. When it is determined based on the determination result that the first reproduction management information is new, a reproduction management information selecting section 304b specifies the reproduction signal processing system to reproduce the contents by use of the first reproduction management information. Further, when the second reproduction management information is new, it specifies the reproduction signal processing system to reproduce the contents by use of the second reproduction management information. The reproduction signal processing system to be specified contains a reproduction control section 305.

The reproduction control section 305 controls a reproduced signal processing system to reproduce the contents by use of the reproduction management information selected by the reproduction management information selecting section.

A network connection processing section 306 can fetch the second reproduction management information held in the second reproduction management information holding section 302. The first reproduction management information held in the first reproduction management information holding section 301 is information read out from the optical disc 1001.

Further, an abnormal checking section 307 for reproduction management information is provided. The checking section 301 can determine whether abnormality occurs in the reproduction management information used by the reproduction control section 305 in the course of reproduction of video and audio information read out from the optical disc 1001. When the checking section 305 detects abnormality, a reproduction management information switching section 308 switches the reproduction management information used by the reproduction control section 305 to another reproduction management information.

Further, a re-updating section 309 for reproduction management information is provided and the re-updating section 309 can re-update reproduction information used by the reproduction control section 305 when the checking section 307 detects abnormality of the reproduction management information. In addition, the re-updating section 309 for reproduction management information can perform a process of fetching reproduction management information again from the network when the version of the reproduction management information among the first and second reproduction management information items which is fetched from the network is older than that of the reproduction management information from the disc. The reason is to always use the newest reproduction management information.

Further, a display processing section 310 is provided and it can display that reproduction management information to be used is abnormal when the checking section 307 detects abnormality. The display section 310 suggests the user to select one of the reproduction management information items when a plurality of reproduction management information items are provided as will be described later.

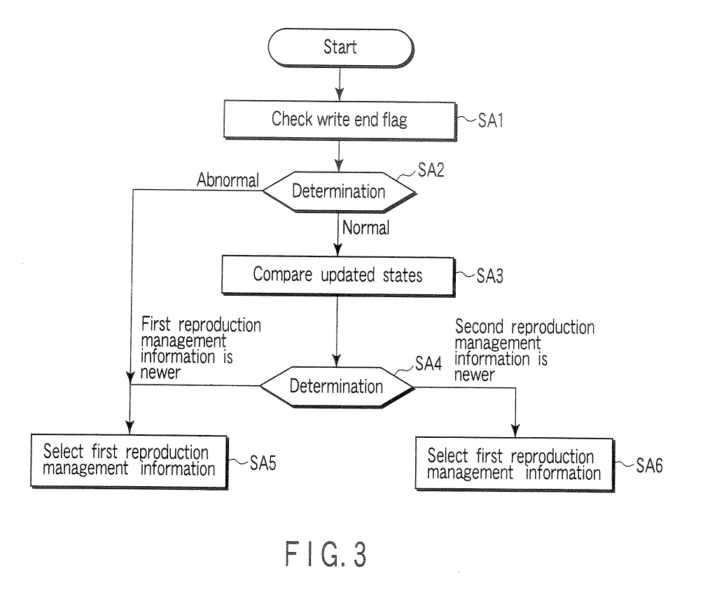

FIG. 3 shows one characteristic example when an optical disc is loaded on the information reproducing apparatus and reproduction of the optical disc is started. A write end flag attached to the second reproduction management information explained in FIG. 2 is checked (step SA1). If the write end flag is normal (step SA2), version information items of the first and second reproduction management information items are compared to determine the newest one of the version information items (step SA3, SA4).

If the first reproduction management information is the new, for example, there is a strong possibility that a revised disc is loaded although the disc has the same title. In this case, it is determined that the first reproduction management information is new and the first reproduction management information is selected and used for reproduction. However, when it is determined in the steps SA3, SA4 that the second reproduction management information is new, the second reproduction management information is selected and used for reproduction.

If it is determined in the step SA2 that the write end flag is abnormal, the flow in which the first reproduction management information is used is performed. The reproduction management information items to be dealt with are held in a table form and managed for each disc identification information or for each disc number in the management information holding section, for example. Therefore, there occurs no possibility that the second reproduction management information which is compared with the first reproduction management information is the reproduction management information of a disc which is quite different from that of the disc now loaded.

As described above, according to the present apparatus, as the reproduction management information, the newest reproduction management information with respect to the optical disc to be reproduced is used and the reproducing operation is performed. In this case, if an error or fault occurs in the newest reproduction management information fetched from the network, the reproduction apparatus will not fall into a deadlock state since original reproduction management information originally recorded on the disc is used.

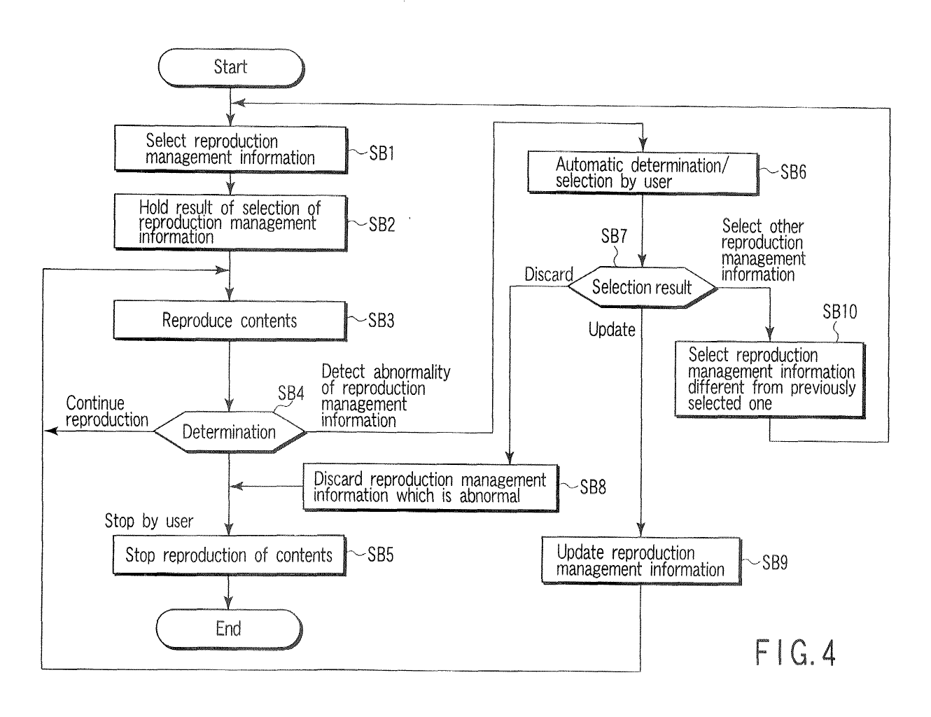

This invention is not limited to the above embodiment. As shown in FIG. 4, normality or abnormality of the reproduction management information may be checked while the reproduction management information is selected and used and the processing countermeasure can be taken when abnormality occurs. It is supposed that the reproduction management information is selected and the reproducing operation by the reproducing apparatus is started (step SB1). At this time, information indicating one of the reproduction management information items which is selected is held in a buffer memory (not shown) (step SB2). The operation of reproducing the contents is continuously performed (steps SB3, SB4).

It is supposed that abnormality is detected in the reproduction management information which is now used in the course of reproduction of the contents. Then, in this case, a message indicating occurrence of abnormality is displayed on the display section. At this time, the user may operate the reproducing apparatus to stop the operation of the reproducing apparatus (step SB5). However, it is also possible to set the automatic operation process. In this case, the user can set the following automatic operation process.

(a) The reproduction management information which is detected to be abnormal is discarded and the reproduction process is terminated (steps SB6, SB7, SB8).

(b) The reproduction management information which is now used is subjected to the re-updating operation (step SB7, SB9) and the process returns to the contents reproducing mode (step SB3).

(c) Reproduction management information different from the reproduction management information which is now used is selected (step SB10) and the process returns to the first step SB1.

Thus, the contents reproducing operation can be continuously performed by previously setting the automatic processing mode and using different reproduction management information or re-updating the reproduction management information even if abnormality occurs in the reproduction management information in the course of reproduction.

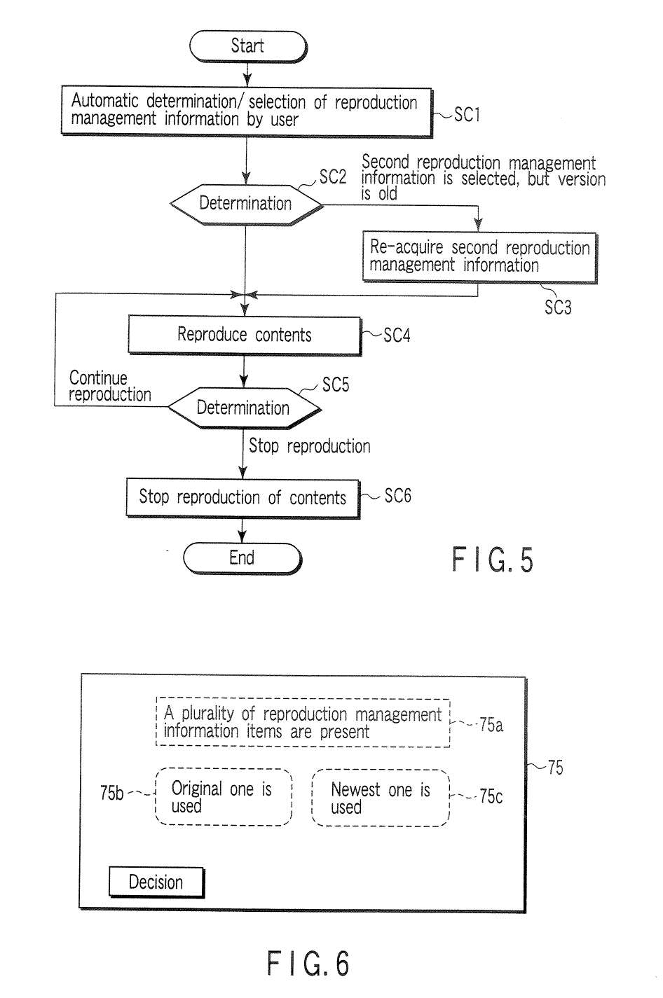

FIG. 5 shows another embodiment of this invention. As shown in FIG. 6, for example, this example is effective in a case where the fact that a plurality of reproduction management information items are present is displayed on the menu screen of a monitor 75 and notified and the user selects one of the information items. That is, a comment 75a of “a plurality of reproduction management information items are present” is displayed on the menu screen when a disc is loaded as shown in FIG. 6 and selection buttons are displayed. For example, a selection button 75b indicating “original information is used” and a selection button 75c indicating “the newest information is used” are displayed. The user specifies management information to be used by operating the remote controller, moving the cursor to one of the selection buttons and depressing the decision button. The explanation is made with reference to FIG. 5 again. It is now assumed that second reproduction management information held by a second management information holding section 302 is selected (step SC1). At this time, a newest information determining section 304a compares versions of the first and second reproduction management information items and determines an older one of the information items (step SC2). At this time, it is supposed that the version of the second reproduction management information is older than that of the first reproduction management information read out from the disc (step SC2). In this case, there is a strong possibility that the second reproduction management information is updated to a new version on the server side. Therefore, a re-acquisition process is performed to re-update the second reproduction management information (step SC3).

When the re-acquisition process is performed, reproduction of the contents is performed (step SC4), and if a stop command is issued (step SC5), the reproduction process is interrupted and terminated (step SC6).

The above apparatus is shown as the reproduction-only apparatus as shown in FIG. 1, but this invention is not limited to the reproduction-only apparatus.

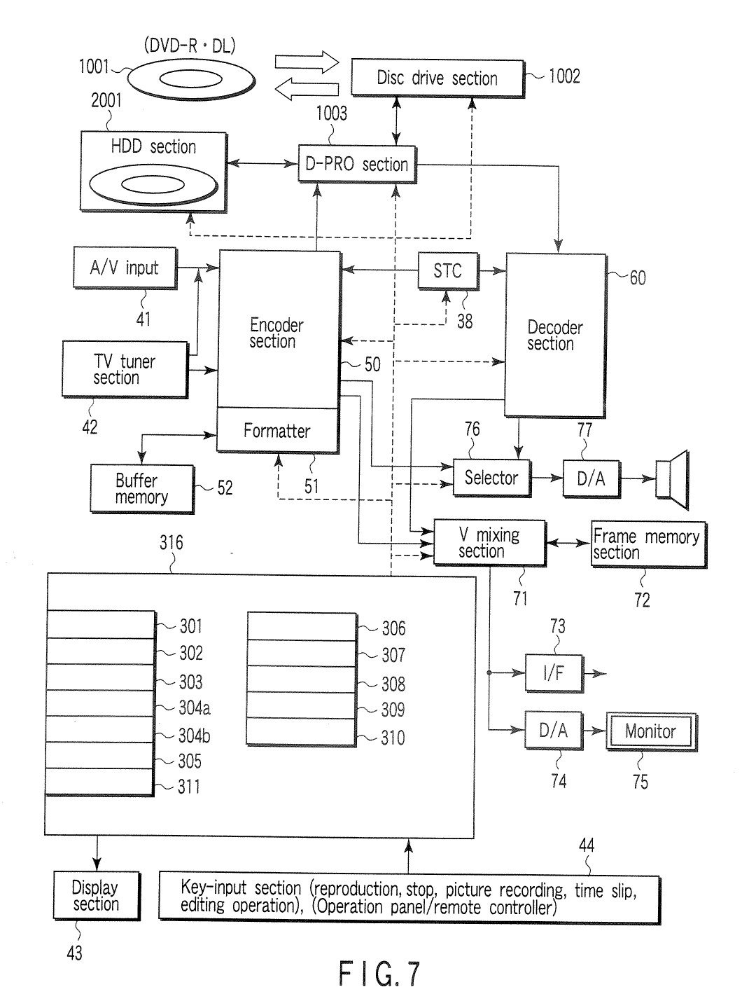

FIG. 7 shows another embodiment of an information recording/reproducing apparatus to which this invention is applied. The same function and effect as those of the former embodiment can be attained if this invention is applied to the information recording/reproducing apparatus. The explanation thereof is simply made below. The information recording/reproducing apparatus has two types of disc drive sections. Further, it includes a disc drive section 1002 which rotates and drives the optical disc 1001 as explained before and performs an information reading/writing process. In addition, it includes a hard disc drive section 2001 which drives a hard disc (HDD) as a second medium. A data processor 1003 includes the gain adjustment unit 22, signal processing circuit 23 and data processing circuit 24 of FIG. 1.

The data processor section 1003 can supply recording data to the disc drive section 1002 and hard disc drive section 2001 and receive a reproduced signal. The disc drive section 1002 includes a rotation control system for the optical disc 1001, laser drive system (using red laser with the wavelength of 650 nm or blue laser with the wavelength of 405 nm or less), optical system and the like. The data processor section 1003 deals with data in the recording or reproducing unit and includes a buffer circuit, modulation/demodulation circuit, error correcting section and the like.

The information recording/reproducing apparatus of FIG. 7 has an encoder section 50 configuring a recording section, a decoder section 60 configuring a reproducing section and a microcomputer block (which can also be referred to as a system control section) 30 which controls the operation of the apparatus main body as main constituents. The microcomputer block 30 corresponds to the system controller 30 described before.

The encoder section 50 includes a video and audio analog-digital converter which converts an input analog video signal and analog audio signal into a digital form, a video encoder and an audio encoder. Further, it includes a sub video encoder. An output of the encoder section 50 is converted into a preset format of DVD-RAM by a formatter 51 containing a buffer memory and supplied to the data processor section 1003 described before. An external analog video signal and external analog/audio signal from the AV input section 41 or an analog video signal and analog audio signal from the TV tuner section 42 are input to the encoder section 50.

In the video encoder contained in the encoder section 50, a digital video signal is converted into a digital video signal compressed at a variable bit rate based on the MPEG2 (or MPEG1 or MPEG4-AVC) standard. A digital audio signal is converted into a digital audio signal of linear PCM or a digital audio signal compressed at a fixed bit rate based on the MPEG or AC-3 standard.

In the present apparatus, information (packs of video, audio, sub video information and the like) formatted by the formatter 51 and management information formed can be supplied to the hard disc drive section 2001 or data disc drive section 1002 via the data processor section 1003 and recorded on the hard disc or optical disc 1001. Further, information recorded on the hard disc or optical disc 1001 can be supplied via the data processor section 1003 and disc drive section 1002 and recorded on the optical disc 1001 or hard disc.

An MPU of the microcomputer block 30 performs the faulty portion detecting process, unrecorded area detecting process, recorded information recording position setting process, UDF recording process, AV address setting process, history information retrieving process and the like by using the RAM as a work area according to a control program stored in the ROM. The microcomputer block 30 has an information processing section required to generally control the whole system and includes a VMG (whole video management information) information forming section, copy associated information detecting section, copy and scrambling information processing section (RDI processing section), packet header processing section, sequence header processing section and aspect ratio information processing section (not shown) in addition to a firmware ROM, work RAM and directory detecting section.

In the present apparatus, an extent expressing the access unit is defined by use of size information of data and address with respect to the data recording area of the information recording medium and data is recorded and reproduced by using a file entry containing a plurality of extents to manage the file.

Contents to be notified to the user among the execution results of the MPU are displayed on the display section 43 of the video data recording/reproducing apparatus or OSD (On-screen display) displayed on a monitor display 75. The microcomputer block 30 has a key-input section 44 which generates an operation signal used to operate the apparatus. The key-input section 44 corresponds to operation switches or remote control device provided on the main body of the video recording apparatus, for example. Further, the key-input section 44 may be the network interface described before or a personal computer connected to the video recording apparatus according to one embodiment of this invention by use of means such as wired communication, radio communication, optical communication or infra-red communication.

Timings at which the microcomputer block 30 controls the disc drive section 1002, hard disc drive section 2001, data processor section 1003, encoder section 50 and/or decoder section 60 can be determined based on time data from an STC (system time clock) 38. The recording and reproducing operations are normally performed in synchronism with the time clock from the STC 38, but the other processes may be performed at timings independent from the time data of the STC 38.

The decoder section 60 includes a separator which separately takes out respective packs from a signal of the DVD format having the pack structure, a memory used at the pack separation time and other signal process executing time, a V decoder which decodes main video data (the contents of a video pack) separated by the separator, an SP decoder which decodes sub video data (the contents of a sub video pack) separated by the separator, and an A decoder which decodes audio data (the contents of an audio pack) separated by the separator. Further, it includes a video processor which properly synthesizes the decoded main video data with the decoded sub video data, superimposes a menu, highlight button, subtitles and other sub video data on the main video data and outputs the thus superimposed data.

The output video signal of the decoder section 60 is input to a video mixing section 71. In the video mixing section 71, the operation of synthesizing text data items is performed. The video mixing section 71 is connected to a line used to directly fetch a signal from the TV tuner 42 and A/V input section 41. Further, the video mixing section 71 is connected to a frame memory 72 used as a buffer. When an output of the video mixing section 71 is an analog output, it is output to the exterior via an I/F (interface) 73, and when the output is a digital output, it is output to the exterior via a digital-analog converter 74.

An output audio signal of the decoder section 60 is supplied to a digital-analog converter 77 via a selector 76, converted into an analog signal and output to the exterior.

The data processor section 1003 receives data in the VOBU unit from the formatter of the encoder section 50 and supplies data in the extent unit to the disc drive section 1002 or hard disc drive section 2001. Further, the MPU of the microcomputer block 30 forms management information required for reproducing recorded data, and if it recognizes a command indicating a data recording end, it supplies the formed management information to the data processor 1003. Thus, the management information is recorded on the disc. Therefore, the MPU of the microcomputer block 30 receives information (such as separating information) in the data unit from the encoder section 50 while the encoding process is being performed. Further, the MPU of the microcomputer block 30 recognizes management information (file system) read out from the optical disc or hard disc at the record starting time, recognizes an unrecorded area of each disc and sets a data recording area on the disc via the data processor section 1003.

As described above, according to this invention, an information reproducing apparatus and method which can ensure the reproduction state of the apparatus even when a trouble occurs in the updated information are provided. Further, an information reproducing apparatus and method which can utilize original information are provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
a first management information holding section which holds first reproduction management information used to reproduce contents of an information recording medium,
a second management information holding section which holds second reproduction management information used to reproduce the contents of the information recording medium,
a flag determining section which determines whether a write end flag attached to the second reproduction management information is normal,
a newest information determining section which determines version information items of the first and second reproduction management information items and determines a new one of the management information items when it is determined that the write end flag is normal,
a reproduction management information selecting section which specifies reproduction of the contents by use of the first reproduction management information when the first reproduction management information is new and specifies reproduction of the contents by use of the second reproduction management information when the second reproduction management information is new, and
a reproduction control section which controls reproduction of the contents by use of the reproduction management information selected by the reproduction management information selecting section.

2. The information reproducing apparatus according to claim 1, further comprising a network connection processing section which fetches the second reproduction management information held in the second management information holding section via a network from the exterior.

3. The information reproducing apparatus according to claim 1, wherein the first reproduction management information held in the first management information holding section is information read out from the information recording medium.

4. The information reproducing apparatus according to claim 1, further comprising a checking section which determines whether abnormality occurs in reproduction management information used by the reproduction control section in the course of reproduction of video and audio information read out from the information recording medium, and a switching section which switches reproduction management information used by the reproduction control section to different reproduction management information when the checking section detects occurrence of abnormality.

5. The information reproducing apparatus according to claim 1, further comprising a checking section which determines whether abnormality occurs in reproduction management information used by the reproduction control section in the course of reproduction of video and audio information read out from the information recording medium, and a re-updating section which re-updates reproduction information used by the reproduction control section when the checking section detects occurrence of abnormality.

6. The information reproducing apparatus according to claim 1, further comprising a checking section which determines whether abnormality occurs in reproduction management information used by the reproduction control section in the course of reproduction of video and audio information read out from the information recording medium, and a display processing section which generates a display signal to display that reproduction management information to be used is abnormal when the checking section detects occurrence of abnormality.

7. The information reproducing apparatus according to claim 1, further comprising a newest information determining section which compares versions of the first and second reproduction management information items to determine a newer one of the reproduction management information items when the reproduction management information selecting section selects the second reproduction management information based on an operation input, and a re-updating section (309) which re-updates the second reproduction management information when the version of the second reproduction management information is older.

8. An information reproducing method for an apparatus including a reading section which reads out information from an information recording medium, a signal processing section which processes a signal output from the reading section, a control section which controls a reproducing operation, and a network interface connected to an external network under control of the control section, comprising:
holding first reproduction management information output from the signal processing section,
holding second reproduction management information fetched from the network interface,
determining whether a write end flag attached to the second reproduction management information is normal,
determining version information items of the first and second reproduction management information items and determining a newer one of the management information items when it is determined that the write end flag is normal,
specifying reproduction of contents by use of the first reproduction management information when the first reproduction management information is newer and specifying reproduction of the contents by use of the second reproduction management information when the second reproduction management information is newer, and
controlling reproduction of the contents by use of the first or second reproduction management information.

9. The information reproducing method according to claim 8, further comprising determining whether abnormality occurs in the reproduction management information which is now used in the course of reproduction of video and audio information read out from the information recording medium, and switching the reproduction management information used by the reproduction control section to different reproduction management information when occurrence of abnormality is detected.

10. The information reproducing method according to claim 8, further comprising determining whether abnormality occurs in the reproduction management information which is now used in the course of reproduction of video and audio information read out from the information recording medium, and re-updating reproduction information used by the reproduction control section when occurrence of abnormality is detected.

11. The information reproducing method according to claim 8, further comprising determining whether abnormality occurs in the reproduction management information which is now used in the course of reproduction of video and audio information read out from the information recording medium, and generating a display signal to display that reproduction management information to be used is abnormal when occurrence of abnormality is detected.

12. The information reproducing method according to claim 8, further comprising comparing versions of the first and second reproduction management information items to determine a newer one of the reproduction management information items when the second reproduction management information is selected based on an operation input, and re-updating the second reproduction management information via a network when the version of the second reproduction management information is older.
